(19) United States
(12) Patent Application Publication
(10) Pub. No.: US 2023/0073910 A1
(43) Pub. Date: Mar. 9, 2023

(54) MICROBIAL ELECTROCHEMICAL LIGNIN AND ALKALINE HYDROXIDE RECOVERY FROM DEACETYLATION AND MECHANICAL REFINING OF BLACK LIQUOR

(71) Applicant: Alliance for Sustainable Energy, LLC, Golden, CO (US)

(72) Inventor: Xiaowen CHEN, Littleton, CO (US)

(21) Appl. No.: 17/898,420

(22) Filed: Aug. 29, 2022

Related U.S. Application Data
(60) Provisional application No. 63/238,056, filed on Aug. 27, 2021.

(51) Int. Cl. C25B 9/19; C25B 1/04; C25B 1/16; C25B 3/07; C25B 5/00; C02F 3/00

(52) U.S. Cl. CPC C25B 9/19; C25B 1/04; C25B 1/16; C25B 3/07; C25B 5/00; C02F 3/005; C02F 2101/30

(57) ABSTRACT

Disclosed herein is 4-chamber microbial electrolysis process and apparatus that recovers lignin, NaOH, and H₂ products while removing waste organics from deacetylation and mechanical refining black liquor.

### CROSS-REFERENCE TO RELATED APPLICATION

This application claims priority under 35 U.S.C. 119(e) to U.S. Provisional Application No. 63/238,056 filed 27 Aug. 2021, the contents of which are incorporated herein by reference.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

Biorefining is a fast-growing industry that converts biomass into renewable products such as biofuels, bioenergy, and biomaterials. Due to the recalcitrant nature of lignocellulosic biomass, pretreatment is required to selectively fractionate and solubilize the polymers and generate a highly complex concentrated waste stream generally called black liquor (BL). Deacetylation and mechanical refining (DMR) is an emerging pretreatment process that uses dilute alkali deacetylation in mild conditions and saponifies acetyl groups from the xylan backbone of biomass, which improves fermentability and reduces the recalcitrance of biomass. The black liquor generated from DMR is diluted, so traditional Kraft concentration process followed by incineration can't be applied, and no heat or chemical could be recovered. Large consumption of NaOH is a major concern in DMR due to the high cost and environmental impacts. It was estimated 40-80 kg NaOH is consumed per ton biomass treated using DMR that NaOH usage alone contributes approximately $1/gallon gasoline equivalent (GGE) to the overall minimum fuel selling price (MFSP), which becomes a major barrier to achieving the $2.50/GGE goal in 2030. In addition, supply chain sustainability analysis indicated that NaOH consumption was one of the major contributors to overall biorefinery GHG emission. Therefore, it becomes imperative to develop a method that not only can treat DMR black liquor but also recover the alkali solution to offset NaOH consumption.

Downstream black liquor recycling could save water, chemical and energy usage without inhibiting downstream ethanol fermentation, and enzymes have been used to convert xylooligosaccharide in black liquor to monomeric sugars for improving the product yield. However, these methods can't fulfill the need of both treatment and chemical recovery in one system. Recognizing the potential synergies between the function needs, a microbial electrochemical technology (MET) platform is believed to carry good potentials to recover alkali from black liquor while removing organic waste. MET employs electroactive bacteria (EAB) to convert biodegradable waste into current in the anode chamber, which can be used in situ to boost electrolysis or chemical recovery in the cathode. The pH gradient generated between the different reactor chambers during MET operation was utilized to treat DMR wastewater to precipitate lignin, oxidize soluble acids, and recover salt ions from the concentrates, but it didn't tackle the major barrier in DMR operation which is alkali consumption.

### SUMMARY

In an aspect, disclosed herein are a microbial electrolysis process that is capable of recovering lignin, NaOH, and H₂ products while removing waste organics from deacetylation and mechanical refining (DMR) black liquor. In an embodiment, disclosed herein is a system incorporating the microbial electrolysis process that is capable of recovering lignin, NaOH, and H₂ products while removing waste organics from deacetylation and mechanical refining (DMR).

In an aspect, disclosed herein is a four-chambered microbial electrolysis cell useful for the treatment of black liquor and recovery of alkali wherein the electrolysis cell comprises an anode chamber, a cathode chamber, an acidic chamber and an alkalic chamber wherein the anode chamber degrades organic material and generates current; and wherein the cathode chamber generates H2; and wherein the acidic chamber precipitates lignin from the black liquor; and wherein alkali is recovered from the alkalic chamber. In an embodiment, the anode chamber is adjacent to the acidic chamber which is adjacent to the alkalic chamber which is adjacent to the cathode chamber. In an embodiment, the anode chamber is separated from the acidic chamber by a bipolar membrane. In an embodiment, the acidic chamber is separated from the alkalic chamber by a cation exchange membrane. In an embodiment, the alkalic chamber is separated from the cathode chamber by a bipolar membrane. In another embodiment, the anode chamber is separated from the acidic chamber by a bipolar membrane; and wherein the acidic chamber is separated from the alkalic chamber by a cation exchange membrane; and wherein the alkalic chamber is separated from the cathode chamber by a bipolar membrane. In an embodiment, the black liquor is derived from the deacetylation and mechanical refining of biomass. In an embodiment, 52% of the organic weight of the black liquor is removed in the anode chamber. In an embodiment, the alkali is recovered from the alkalic chamber at a concentration of up to 83 mM. In an embodiment, the alkali is NaOH. In an embodiment, a voltage of from 0.8 V to 1.4 V is applied to the cell. In an embodiment, the lignin precipitated in the acidic chamber is recovered at up to 14 grams per liter of black liquor. In an embodiment, the H₂ generated in the cathode chamber is generated at a rate of up to 0.35 liters per liter of black liquor per day. In an embodiment, the H₂ is generated at a faradaic efficiency of up to 93.5%. In an embodiment, the anode chamber comprises electroactive bacteria.

In an aspect, disclosed herein is a method of recovering lignin and alkali from deacetylation and mechanical refining black liquor comprising contacting a four-chambered microbial electrolysis cell comprising an anode chamber that is adjacent to an acidic chamber that is adjacent to an alkalic chamber that is adjacent to a cathode chamber; and wherein the anode chamber is separated from the acidic chamber by a bipolar membrane; and wherein the acidic chamber is separated from the alkalic chamber by a cation exchange membrane; and wherein the alkalic chamber is separated from the cathode chamber by a bipolar membrane; wherein the anode chamber of the four-chambered microbial electrolysis cell comprises electroactive bacteria; and wherein the anode chamber is contacted with the black liquor. In an embodiment, the lignin is recovered from the acidic chamber. In an embodiment, the alkali is recovered from the alkalic chamber. In an embodiment, the alkali is NaOH. In an embodiment, H₂ is produced in the cathode chamber.

Other objects, advantages, and novel features of the present invention will become apparent from the following detailed description of the invention when considered in conjunction with the accompanying drawings.

### BRIEF DESCRIPTION OF THE DRAWINGS

FIG. 1 depicts a schematic of the 4-chamber microbial electrolysis cell showing the charge transfer and the corresponding function achieved in each chamber. Left insets show ESEM images of biofilm growing on carbon brush fiber. Right inset shows the porous nature of the Nickel foam cathode. EAB: electroactive bacteria; CEM: cation exchange membrane; BPM: bipolar membrane.

FIG. 2 depicts performance metrics of an exemplary 4-chamber microbial electrolysis cell. FIG. 2A depicts a time-course pH changes under different applied voltages; FIG. 2B depicts NaOH recovery in the alkalic chamber and the corresponding current under tested voltage; FIG. 2C depicts lignin recovery under tested voltages. Current is averaged across each duration of the experiments.

FIG. 3 depicts production rates of H₂ and chemical oxidation demand removal rates at voltages of 0.8 V, 1.0 V, 1.2 V and 1.4 V. FIG. 3A depicts H₂ production in the cathode chamber and the corresponding faradaic efficiency. FIG. 3B depicts chemical oxygen demand (COD) removal rates of electrolytes in anode and acidic chamber.

FIG. 4 depicts charge transfer profile and current utilization factor at voltages of 0.8 V, 1.0 V, 1.2 V and 1.4 V. FIG. 4A depicts charge transfer profile under four different applied voltages and the corresponding external charge transfers. FIG. 4B depicts current utilization factor (CUF) calculated of the microbial electrolysis cell (MEC) reactor and its distribution. The external charge represents the charge transfer within the external circuit and is directly calculated from the current profile.

FIG. 5 depicts the Nyquist Plots of the MEC anode and the abiotic anode. FIG. 5B depicts shows the high-frequency end of the entire panel at depicted in FIG. 5A.

### DETAILED DESCRIPTION

Disclosed herein are methods, systems and processes that incorporate the design of microbial electrolysis to maximize the benefits of DMR black liquor treatment and alkali recovery, so the generated NaOH could be directly reused to further DMR process and reduce cost and environmental impacts. We employed a bipolar membrane separator that generated tailored pH profiles in different chambers, which enabled four differential functions in the respective chambers. Organic degradation was carried out by microbes in the anode chamber, and H₂ production was realized in the cathode chamber. More importantly, the acidic chamber was created to precipitate lignin in black liquor, while the alkalic chamber realized NaOH recovery. The microbial electrolysis cell (MEC) doesn't require electrolyte circulation and showed good pH stability, further reduced energy demand. In addition, we derived a concept called current utilization factor (CUF) to quantify the multifunctionality of current in MEC.

Multifunctionality for Concurrent Black Liquor Treatment and Resource Recovery

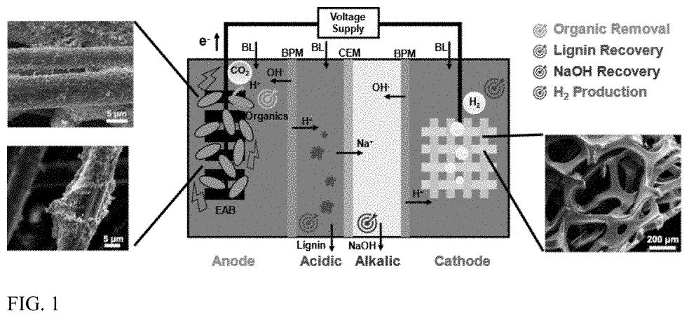

The MEC design in this study enables four different functions that are desired in black liquor treatment: organic degradation and current generation (anode), H₂ production (cathode), lignin precipitation and recovery (acidic chamber), and NaOH recovery (alkalic chamber) (FIG. 1). As shown in FIG. 1, by placing a cation exchange membrane (CEM) in between two bipolar membranes (BPMs), each chamber contributes to a unique function based on ion and electron transfers. In a traditional two-chamber MEC, organic oxidation in the anode chamber often leads to acidification if insufficient buffer was provided, while the opposite challenge occurs in the cathode chamber, in which H₂ loss leads to pH increase. By recognizing such gradient and taking advantage of the high concentration of other ions in DMR black liquor, the four-chamber design added an additional acid chamber next to the anode to enable lignin precipitation in the acidic environment, so the solid can be recovered and fouling can be mitigated. In addition, the high concentration of Na⁺ present in the black liquor combines with OH− migrated from the cathode chamber to recover NaOH for reuse in the alkalic chamber. The BPMs offset the pH imbalances in the anode and cathode chambers by generating OH⁻ and H+ respectively. FIG. 1 also shows the scanning electron microscope (ESEM) biofilm coverage on the anode for black liquor organic removal and the porous structure of the Nickel foam cathode.

pH Differentiation Enabled Stable Redox Reactions in the Anode and Cathode and Targeted Lignin and NaOH Recovery

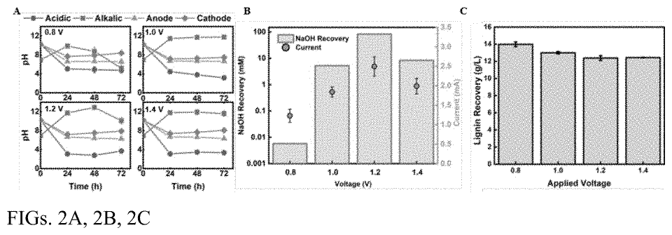

Tailoring the pH value is a consideration for realizing the desired functionalities in different chambers. FIG. 2A demonstrates the time-course pH changes in each chamber under different applied voltages (0.8, 1.0, 1.2, 1.4V). There exists a clear distinction between the pH profile of anode, cathode chambers and that of acidic, alkalic chambers. Because black liquor was directly used as the feedstock for anode, cathode, and acidic chambers, the initial pH in these chambers were around 10. It can be seen from FIG. 2A that under all four voltages, the pH in anode and cathode chambers drops to near neutral within 24 hours and maintained stable thereafter. This clearly highlights the water splitting benefits of the bipolar membranes which stabilized the pH in the anode and cathode chambers and offset H⁺ diffusion need from the anode. Stable neutral pH is critical in maintaining the microbial activities and electron transfers on the anode as well as thermodynamically favorable hydrogen evolution reaction (HER) on the cathode. On the other hand, the pH profiles in the acidic and alkalic chambers showed different patterns. The pH quickly dropped in the acidic chamber as H⁺ produced at the interfacial region of the bipolar membrane (BPM) migrates in, which enabled lignin precipitation from the black liquor feedstock. The rate at which the pH dropped was positively correlated with the applied voltage, as higher voltages sustained higher water splitting rate and ion migration rate. The pH in the alkalic chamber exhibited an opposite trend, with higher voltages led to steeper pH increase within the first day, which was ideal for NaOH generation. While higher voltage maintained the high pH, the 0.8 V voltage didn't show sufficient driving force for water splitting and OH⁻ migration, which led to a reversal overtime.

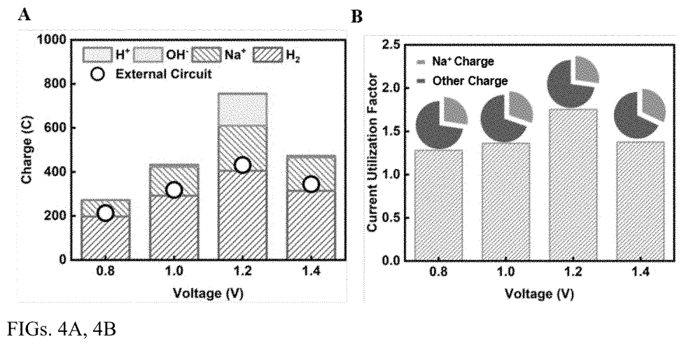

During the operation of microbial electrolysis cells (MEC) on each voltage, the current response was stable, rationalizing the method of using an average current to represent the current profile. FIG. 2B summarizes the final NaOH recovery in the alkalic chambers, and the average current under each applied voltage. The NaOH concentrations were represented by the concentration of OH− as Na+ concentrations are always higher under all testing conditions (FIG. 4A). There is a clear positive correlation between the current and the final pH gradient. When the applied voltage increased from 0.8 V to 1.2 V, the resulting current increased correspondingly from 1.23 mA to 2.50 mA (FIG. 2B), leading to more substantial pH gradients between the acidic and alkalic chamber represented by larger height differences between the blue and red dots in FIG. 2A. The highest pH achieved in the alkalic chamber was 12.92±0.44, representing a maximum OH⁻ recovery of 83.2 mM (FIG. 2B). Further elevating the applied potential from 1.2 V to 1.4 V did not lead to further increase in the average current, nor did it achieve higher NaOH titer in the alkalic chamber. This is consistent with what we observed in the abiotic control experiments, where higher current not necessarily resulted from higher applied voltage. Similar trend was reported in previous MEC studies and other applications, and the reason can be related to inhibition of bioanode activity at high voltages owing to induced oxygen evolution reaction (OER) which is detrimental to the bioanode. Without being bound by theory, another possible explanation is that at higher voltage, the cells undergo greater plasmatorrhexis, resulting in slower metabolisms.

The DMR process consumes a significant amount of alkali, which has been a primary economic and environmental barrier in large scale applications. The NaOH recovered in the MEC can be directly reused in DMR without further post-treatment since a simple electrolyte (NaCl solution) was used as the draw solution. Water splitting rate and OH− migration rate into the alkalic chamber were positively correlated with the current. Although higher current could potentially lead to more unwanted H+ transfer across a cation exchange membrane (CEM), this factor did not offset the OH⁻ migration as higher current always resulted in higher NaOH recovery under all experimental conditions explored in this study (FIG. 2B). In contrast, when a same current density was obtained in an abiotic electrolysis cell control with the same electrolyte, it consumed higher energy than the MEC. For instance, when supplying a 2.5 mA average current, the abiotic cell required an average voltage of 2.5 V, which more than doubled the voltage (1.2 V) needed by the MEC. This was mainly attributed to higher overpotential loss in the abiotic cell control, primarily due of lack of biocatalysts on the anode. Besides higher energy consumption, the abiotic cell control also showed a smaller pH gradient in the middle chambers, resulting in a much smaller NaOH titer recovered in the alkalic chamber.

The lignin recovery in the acidic chamber is summarized in FIG. 2C. Under all tested voltages, the lignin recovery was higher than 12 g/L with the highest lignin recovery of 13.98±0.28 g/L achieved at an applied voltage of 0.8 V. The higher voltage didn't result in higher recovery, rather slightly lower recovery was observed. Without being bound by theory, the reason was believed to be associated with the optimal pH for lignin precipitation. A separate control experiment on identifying the optimal pH was carried out and found a pH 4.5 resulted in the best lignin precipitation, while the pH under 0.8 V was 4.73, closest among all experimental conditions. Previous studies reported that over-acidification led to re-solvation of part of the lignin content, which presumably led to lower recovery under higher voltages.

The Electron Flow: From Chemical Oxygen Demand (COD) Degradation to H₂ Production

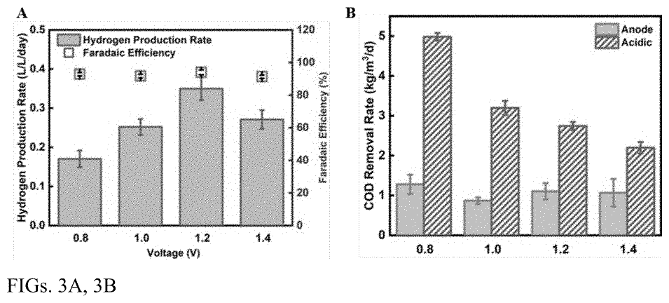

On the cathode side, H₂ was generated via proton reduction, and the recovered H₂ can be used as either energy carrier or chemical feedstock. As shown in FIG. 3A, H₂ production increased with the increasing applied voltage from 0.8 to 1.2 V, then it slightly reduced at 1.4 V. This pattern was consistent with the average current observed under different applied voltages, where 1.2 V features the highest average current. The Faradic efficiency (FE) was over 90% in all circumstances, confirming a good conversion performance overall. The highest H₂ production (103 mL) was achieved at an applied voltage of 1.2 V, with a FE of 93.5%. The corresponding H₂ volumetric production rate was 0.35 L/L/day, further confirming that H₂ production is feasible in embodiment of reactors disclosed herein even when feeding with an alkalic catholyte.

After each batch test, the black liquor electrolyte samples from the anode, acidic, and cathode chambers were collected for measurement of organic removal. The COD removal rates are presented in FIG. 3B and the corresponding COD values are ascertainable. The raw black liquor used in the experiments had a COD value of 28,960±212 mg/L. Under all applied voltages, the acidic chamber showed the highest COD removal rate (2.20-4.98 kg/m³/d), which was considerably higher than COD removal rate in the anode chamber (0.87-1.28 kg/m³/d). The high COD removal rate in the acidic chamber was owing to the precipitation of lignin, as lignin constitutes a significant contribution to the overall COD. The COD removal in the anode chamber, on the other hand, was largely attributed to microbial oxidation of biodegradable organics. Although slower than the acidic chamber, the COD removal rates in the anode chamber were comparable to other microbial electrochemical systems. The cathode chamber showed the lowest COD removal as expected, since there were no removal mechanisms except minimal amount of adsorption.

The distinct pH responses and functions of different chambers were made possible with the presence of the two bipolar membranes (BPMs). When using anion exchange membranes (AEMs) or cation exchange membranes (CEMs), H⁺ or OH⁻ migrates throughout the cell to offset the pH gradients. However, mass transfer limit gave rise to undesired pH imbalance that led to reduced performance of microbial electrochemical systems. By utilizing BPMs as disclosed herein, not only desired pH gradient in the middle chambers were created, but also the anode and cathode pH was stabilized. To confirm such benefits, a control group experiment was carried out by replacing the BPMs with AEMs while keeping all other components the same. The results of the final pH and COD removal rate can be summarized. The control MEC showed the highest COD removal rate (1.2±0.3 kg/m³/d 14.5%) in the anode chamber, rather than the acidic chamber. The unfavorable COD removal in acidic chamber (0.5±0.3 kg/m³/d4.0%) was mainly due to the insufficient pH gradient generated in the middle chambers. Without the protons supplied by water electrolysis in the interfacial region of the BPM, the decrease of pH in the acidic chamber was a result of accumulation of H⁺ and limited migration of OH⁻ to the anode chamber. The final pH in the acidic chamber was as high as 6.61, marking little to no lignin precipitation. It is also noteworthy that the pH in the anode and cathode chamber of the control MEC underwent higher instability in the control reactor. The acidification of the anode chamber and alkalinization of the cathode chamber will ultimately lead to unfavorable thermodynamics for the COD removal and H₂ evolution. Moreover, the final pH in the alkalic chamber of the AEM control was 8.70, marking considerably lower NaOH recovery.

The MEC demonstrates high current utilization factor

The charge profile was constructed by measuring and calculating charge carried by individual ion species (FIG. 4A). At all applied voltages, the charge carried by H₂, the electron sinks in the system, was the biggest contribution. Following that is the charge carried by Na⁺ that travels from the acidic chamber to the alkalic chamber. The charge contribution by H⁺ and OH⁻ were relatively small but were still sufficient to alter the pH in the middle chambers. The only exception is at 1.2 V, where the charge contribution by OH⁻ is significant because of the relatively high pH value (12.92) it achieves. Under all four applied voltages, the useful charge exceeds the charge transferred in the external circuit, demonstrating an efficient use of energy.

Building on this charge breakdown, we were able to calculate the current utilization factor (CUF) as defined in the methods section. Theoretically, the CUF (tCUF) represents how many times the charges can be utilized in one system, and in this MEC the tCUF of 4 can be achieved with ideal charge transfer, IEMs and ion migration. For the apparent CUF (aCUF), the denominator represents the total charge carried by current in the external circuit and the numerator denotes the “useful” charge carried by migrating ions and Hz. Based on the results, a maximum CUF of 1.74 were achieved at the applied voltage of 1.2 V (FIG. 4B), meaning the current has been used for 1.74 times in average in our system. This value is a representation of the multifunctionality of the MEC. The breakdown of CUF shows that Na⁺ utilization makes up about a quarter of the total CUF under all experimental conditions. It is important to note that, due to the unwanted ion transfer presented in our system (for instance, CEM in our system also allows H+ transfer from the acidic chamber to alkalic chamber), this CUF is an underestimation of how many times the current actually has been used.

Electrochemical Analysis

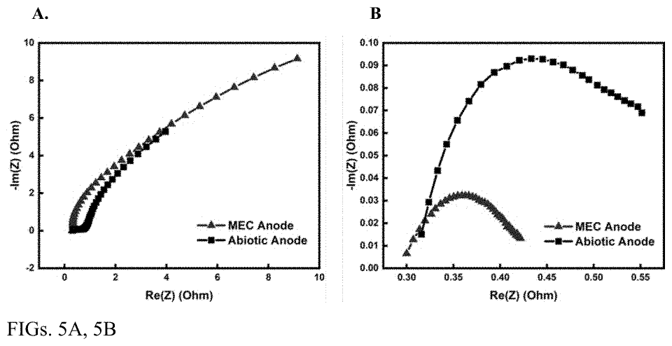

To further elucidate the internal resistance profile, EIS was conducted for the bioanode and the abiotic control without microbial growth. The Nyquist plot is shown in FIG. 5. The MEC bioanode shows a similar pattern as the abiotic anode in the lower frequency end, representing the diffusion-control region (FIG. 5A). However, when zooming into the semicircle region (FIG. 5B), the MEC anode demonstrates a lower diameter than the abiotic anode, meaning the EAB residing on the anode greatly reduced the charge transfer resistance. An equivalent circuit can be proposed and is used to fit the EIS data. The fitting result shows a charge transfer resistance of 5.3±0.3Ω for the MEC anode, and 34.3±1.0Ω for the abiotic anode, indicating a better charge transfer when using bioanode. It is also noteworthy that in the Nyquist plot, the semicircle region is relatively small. Without being bound by theory, this possibly points to a high mass transfer resistance (diffusion-control) compared to charge transfer resistance (reaction-control).

Conclusion

Black liquor is usually considered a highly complex and recalcitrant feedstock for traditional biological treatment, but systems, methods and compositions disclosed herein demonstrate a rationally designed MEC for concurrent black liquor treatment, H₂ production, lignin recovery and NaOH recovery, making use of the synergy between biodegradation, electric field and pH gradient. Previous efforts for electrochemical black liquor treatment using Nafion membrane had shown drastic change of anode pH, leading to sharp increase of anode potential within an hour. Electrodialysis using bipolar membranes was tested before, however the voltage required was an order of magnitude higher than this study and increased exponentially as black liquor pH decreased. Moreover, in previous systems, the lowest obtained black liquor pH was 10.45 as opposed to 2.80 in systems disclosed herein, and NaOH was used as feedstock that further hindered its application from an economic standpoint. With only two middle chambers as disclosed herein, we were able to recover lignin and produce NaOH at the same time. The NaOH can be directly used for replenishing alkali in the pretreatment step of DMR process. Thus, disclosed herein is a platform for black liquor treatment and resource recovery.

Materials and Methods

DMR black liquor feedstock. DMR black liquor samples were obtained from corn stover biomass processed by the Integrated Biorefinery Research Facility at the National Renewable Energy Lab (NREL, Colo., United States). The corn stover was firstly hammer milled and further knife milled to fit the rejection screen size (˜19 mm), and detailed procedure on the DMR process can be found in previous studies. The main composition of the black liquor includes lignin, oligomer sugars, organic acid, and inorganic salts. The chemical oxygen demand (COD) concentration was 28,960±212 mg/L.

Reactor construction and operation. Customized 4-chamber microbial electrolysis cells were assembled for the study. Each cell was equipped with an anode chamber containing a carbon brush anode (5 cm in diameter, 5 cm in length), and a cathode chamber containing a titanium mesh cathode (3×4 cm). An acidic chamber for lignin precipitation and an alkalic chamber for NaOH recovery were placed between the anode and cathode chambers. Two bipolar membranes (Fumasep FBM, FumaTech, Germany) were installed to separate the anode/acidic chambers, and the cathode/alkalic chambers, respectively (FIG. 1). During the MEC start-up stage, black liquor mixed with anaerobic sludge (10:1 v/v) was used as the anode inoculum, and 50 mM phosphate buffer solution was used in all other chambers. The anode was poised at a constant potential of −0.35 V vs Ag/AgCl using a potentialstat (Biologic, France) during inoculation. The SEM images of the carbon brush anode were obtained after stable current output using scanning electron microscope (FEI Quanta ESEM, USA).

After stable current was obtained, the potentiostat was replaced with a DC power source (Labtronix, UK) for external voltage supply. All chambers (anode, cathode, and acidic chamber) were filled with the black liquor except for the alkalic chamber, while 10 g/L NaCl solution was used in the alkali chamber as draw solution and the electrolyte. Four voltages (0.8, 1.0, 1.2 and 1.4 V) were directly applied across the anode and the cathode respectively. The produced H₂ from the cathode was collected by a gas sampling bag (Restek, USA). Current output was recorded by a data acquisition system (Keithley 2700, Tektronix, USA) in a manner similar to previous studies. All MECs were operated in duplicate under ambient room temperature.

Analyses and calculations. At the end of each run, liquid samples in different chambers were sampled separately for chemical analyses. Chemical oxygen demand (COD) measurement was carried out according to the standard protocol using a DR3900 Spectrophotometer (Hach, USA). pH was measured by an Orion Star™ A216 pH meter with Orion 8103BN semi-micro pH electrode (ThermoFisher Scientific, USA). Lignin recovery in the alkalic chamber was measured by centrifuging the sample at 6000 rpm for 10 minutes using Sorvall™ Legend™ XTR Centrifuge (ThermoFisher Scientific, USA), and subsequently dried and weighted. The initial suspended solids of the untreated black liquor were then subtracted from the results. Electrochemical impedance spectroscopy (EIS) tests were conducted using a multichannel potentiostat (Biologic, France), and the frequency ranged from 100 kHz-5 mHz. The sinusoidal perturbation amplitude was 10 mV and the anode potentials were kept at its open circuit potential. Charge transfer resistances were obtained by fitting EIS data to an equivalent circuit. The total charge transfer resistance is the summation of two charge transfer elements.

Measured current utilization factor (CUF) was defined in the following way:

$$C U F = \frac{\vert {Q}_{total} \vert}{\vert {Q}_{current} \vert} = \frac{\vert {Q}_{{H}_{2}} \vert + \vert {Q}_{N {a}^{+}} \vert + \vert {Q}_{{H}^{+}} \vert + \vert {Q}_{{OH}^{-}} \vert}{\vert \int Idt \vert}$$

Where Qₜₒₜₐₗ is the total charge including the contributions from H₂, Na⁺, H⁺ and OH⁻. I is the current in the external circuit and t is operation time. Q_{Na}_{⁺} is the charge carried by sodium ion transferring from the acidic chamber to the alkalic chamber and was measured by Ion Chromatography (IC). Q_{H}_{⁺} is the charge carried by protons that contributes to the acidification of the acidic chamber. Q_{OH}_{^{−}} is the charge carried by hydroxide ions that contributes to NaOH recovery in the alkalic chamber. Q_{H}_{⁺} and Q_{OH}_{^{−}} are quantified by the pH change in acidic chamber and alkalic chamber, respectively. The charge contributions from H₂ is defined as

$${Q}_{{H}_{2}} = \frac{{V}_{{H}_{2}}}{24.5 L / mol} \times \frac{2 mol {e}^{-}}{1 mol {H}_{2}} \times F$$

Where F is the Faraday constant (96,485 C/mol).

Because the CEM allows partial passage of protons, it results in underutilized protons in the acidic chamber and OH− in the alkalic chamber due to migration. Also, there is a discrepancy between the rate of water splitting at the interfacial region of bipolar membranes and the current in the external circuit, the measured CUF is lower than the theoretical limit—tCUF, which is defined as the maximum CUF that can be achieved by the system. Detailed tCUF calculation can be found in the supplementary information (SI). A tCUF of 4 can be reached in this study considering all ions involved.

The foregoing disclosure has been set forth merely to illustrate the invention and is not intended to be limiting.

We claim:

1. A four-chambered microbial electrolysis cell useful for the treatment of black liquor and recovery of alkali wherein the electrolysis cell comprises an anode chamber, a cathode chamber, an acidic chamber and an alkalic chamber wherein the anode chamber degrades organic material and generates current; and wherein the cathode chamber generates H₂; and wherein the acidic chamber precipitates lignin from the black liquor; and wherein alkali is recovered from the alkalic chamber.

2. The electrolysis cell of claim 1 wherein the anode chamber is adjacent to the acidic chamber which is adjacent to the alkalic chamber which is adjacent to the cathode chamber.

3. The electrolysis cell of claim 2 wherein the anode chamber is separated from the acidic chamber by a bipolar membrane.

4. The electrolysis cell of claim 2 wherein the acidic chamber is separated from the alkalic chamber by a cation exchange membrane.

5. The electrolysis cell of claim 2 wherein the alkalic chamber is separated from the cathode chamber by a bipolar membrane.

6. The electrolysis cell of claim 2 wherein the anode chamber is separated from the acidic chamber by a bipolar membrane; and wherein the acidic chamber is separated from the alkalic chamber by a cation exchange membrane; and wherein the alkalic chamber is separated from the cathode chamber by a bipolar membrane.

7. The electrolysis cell of claim 1 wherein the black liquor is derived from the deacetylation and mechanical refining of biomass.

8. The electrolysis cell of claim 1 wherein 52% of the organic weight of the black liquor is removed in the anode chamber.

9. The electrolysis cell of claim 1 wherein the alkali is recovered from the alkalic chamber at a concentration of up to 83 mM.

10. The electrolysis cell of claim 9 wherein the alkali is NaOH.

11. The electrolysis cell of claim 9 wherein a voltage of from 0.8 V to 1.4 V is applied to the cell.

12. The electrolysis cell of claim 1 wherein the lignin precipitated in the acidic chamber is recovered at up to 14 grams per liter of black liquor.

13. The electrolysis cell of claim 1 wherein the H₂ generated in the cathode chamber is generated at a rate of up to 0.35 liters per liter of black liquor per day.

14. The electrolysis cell of claim 13 wherein the H₂ is generated at a faradaic efficiency of up to 93.5%.

15. The electrolysis cell of claim 1 wherein the anode chamber comprises electroactive bacteria.

16. A method of recovering lignin and alkali from deacetylation and mechanical refining black liquor comprising contacting a four-chambered microbial electrolysis cell comprising an anode chamber that is adjacent to an acidic chamber that is adjacent to an alkalic chamber that is adjacent to a cathode chamber; and wherein the anode chamber is separated from the acidic chamber by a bipolar membrane; and wherein the acidic chamber is separated from the alkalic chamber by a cation exchange membrane; and wherein the alkalic chamber is separated from the cathode chamber by a bipolar membrane; wherein the anode chamber of the four-chambered microbial electrolysis cell comprises electroactive bacteria; and wherein the anode chamber is contacted with the black liquor.

17. The method of claim 16 wherein lignin is recovered from the acidic chamber.

18. The method of claim 16 wherein the alkali is recovered from the alkalic chamber.

19. The method of claim 18 wherein the alkali is NaOH.

20. The method of claim 16 wherein H₂ is produced in the cathode chamber.
